(19) United States
(12) Patent Application Publication
(10) Pub. No.: US 2026/0230843 A1
(43) Pub. Date: Aug. 6, 2026

(54) METHODS AND APPARATUSES FOR EXPLAINABLE AI-BASED NETWORK-CONTROLLED SYSTEM OPTIMIZATION

(71) Applicant: InterDigital Patent Holdings, Inc., Wilmington, DE (US)

(72) Inventors: Mohamed Salah Ibrahim, Chesterbrook, PA (US); Yugeswar Deenoo Narayanan Thangaraj, Chalfont, PA (US); Ahmet Serdar Tan, London (GB); Akshay Malhotra, San Jose, CA (US)

(73) Assignee: InterDigital Patent Holdings, Inc., Wilmington, DE (US)

(21) Appl. No.: 19/044,317

(22) Filed: Feb. 3, 2025

(51) Int. Cl. H04W 24/02; H04B 7/06; H04W 24/10

(52) U.S. Cl. CPC H04W 24/02; H04B 7/0626; H04W 24/10

(57) ABSTRACT

A wireless transmit/receive unit (WTRU) may be configured to determine one or more explainability artificial intelligence (XAI) capabilities of the WTRU. The WTRU may receive XAI configuration information from a network that indicates one or more of an explainability mode, an explainability domain type, a configuration of XAI outcome storage, one or more triggers associated with an XAI report, or an XAI report configuration. The WTRU may determine one or more XAI parameters associated with an XAI model. The one or more XAI parameters may indicate features that have a greatest impact on predictions made by an artificial intelligence (AI) or machine learning (ML) inference model. The WTRU may determine to trigger an XAI report based on one or more outcomes of the XAI model. The WTRU may send the XAI report to the network.

### BACKGROUND

As the artificial intelligence (AI) or machine learning (ML) (AIML) model complexity grows, often involving millions and sometimes billions of parameters, their decision-making processes become more opaque. This complexity, while usually resulting in performance improvement of the AIML models, raises significant challenges in understanding and interpreting how these models arrive at their conclusions/decisions. With transparency and trustworthiness being two key aspects of the 6G wireless systems, the lack of understanding of how the AIML models work makes those two aspects cumbersome tasks to achieve, especially with high complex AIML models. This is where explainable AI (XAI) becomes essential. XAI refers to methods and techniques that produce accurate and explainable model of how AI algorithm arrives at a specific decision. Thus, by identifying the underlying logic of AI models, XAI ensures transparency and accountability needed to enable trust towards AI-based solutions in future wireless systems, allowing users to understand what decisions are made and why they are made. This is particularly critical in addressing concerns related to safety and bias/fairness of the AIML model.

XAI can be developed throughout the entire development of the model. Explainability strategies can be categorized into pre-model explanations, in-model explanations and post-model explanations. The Pre-model explanations aim to describe the dataset to gain meaningful insights about the dataset used to train the model. In-model explanations, however, seek to inherently generate explainable models other than black-box models. This can be attained either by adopting a naturally explainable models, e.g., decision trees or linear models or a hybrid model that can be somehow adjusted, e.g., through architectural adjustments, e.g., combining a deeply hidden layer of neural network with KNN, to enable explanations. The third class is the post-model explanations, or model-agnostic X model that can explain the outcomes of any AIML model. From a plethora of XAI techniques, the so-called LIME, SHAP are the most popular model-agnostic explainable AI techniques that can provide post-model explanations. While Lime can provide local (per-feature/sample) explanations by providing scores associated with the impact of each input feature using a simple linear approximation of the original AI model, SHAP provides both local and global explanations of a particular AI model yet at a higher computational cost.

### SUMMARY

Methods and apparatuses may be described herein for artificial intelligence (AI) machine learning (ML) and/or explainability artificial intelligence (XAI) for network controlled optimization with respect to overhead reduction, complexity reduction, and/or storage reduction. Methods and apparatuses may be described herein for determining and reporting XAI parameters for network controlled performance optimization based on wireless transmit/receive unit (WTRU) determined XAI capabilities, one or more triggers, and/or a function of one or more measurements associated with an XAI model outcome satisfying a configured criterion.

A WTRU may be configured to determine one or more XAI capabilities of the WTRU. The WTRU may receive XAI configuration information from a network. The XAI configuration information may include one or more of an explainability mode, an explainability domain type, a configuration of XAI outcome storage, one or more triggers associated with an XAI report, or an XAI report configuration. The WTRU may execute an AIML inference model that is associated with a use-case. The WTRU may activate an XAI model that is associated with the AIML inference model. The XAI model may be activated based on one or more of a WTRU capability availability or an explicit indication from the network. The WTRU may determine one or more XAI parameters associated with an XAI model (e.g., the activated XAI model). The one or more XAI parameters may indicate features that have a greatest impact on predictions made by an artificial intelligence (AI) or machine learning (ML) inference model. The WTRU may determine to trigger an XAI report based on one or more outcomes of the XAI model. The one or more outcomes of the XAI model indicate an importance of one or more features to outputs of the AIML inference model. The WTRU may send the XAI report to the network. The XAI report may include one or more of a cause parameter or the one or more XAI parameters.

The one or more XAI parameters may include one or more of the explainability mode or the explainability domain type. The explainability mode may include one or more of a local explainability mode or a global explainability mode. The explainability domain type may include one or more of a first type where the XAI model provides explanations about input features associated with a given input sample or a second type where the XAI model provides explanations for a series of consecutive input samples. The one or more outcomes of the XAI model may include one or more of scores associated with an importance of input features with respect to an output of the AIML inference model or an inference decision associated with the XAI model. The WTRU may derive an XAI model metric based on one or more of the XAI configuration information or the one or more XAI parameters. The XAI model metric may include one or more of a rank of the input features based on their respective scores, a set of scores greater than a configured threshold, feature indices associated with the scores that are greater than the configured threshold, raw samples to be explained, or a representation of the raw samples. The XAI report may be triggered based on one or more of a performance boosting criteria, a power consumption reduction criteria, or a complexity reduction criteria. The one or more XAI capabilities of the WTRU may include one or more of WTRU supported use-cases to perform XAI, a supported explainability mode for each of the use-cases, computational resources for each of the use-cases to perform XAI, a maximum number of computational resources that can be used to support XAI, or a maximum number of storage resources for XAI samples. The WTRU supported use-cases may include one or more of CSI prediction, beam management, or PMI selection.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flow chart depicting an example procedure for explainable artificial intelligence (XAI) based optimization.

### DETAILED DESCRIPTION

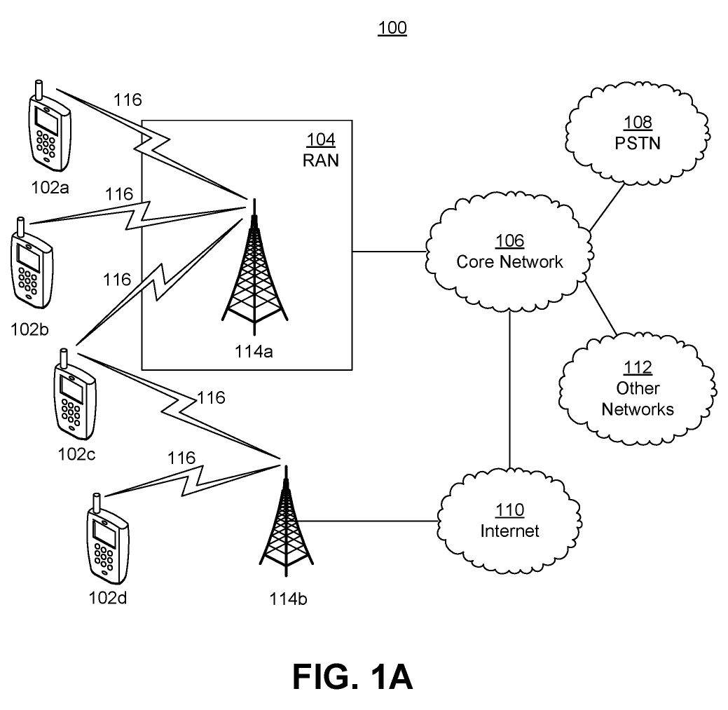

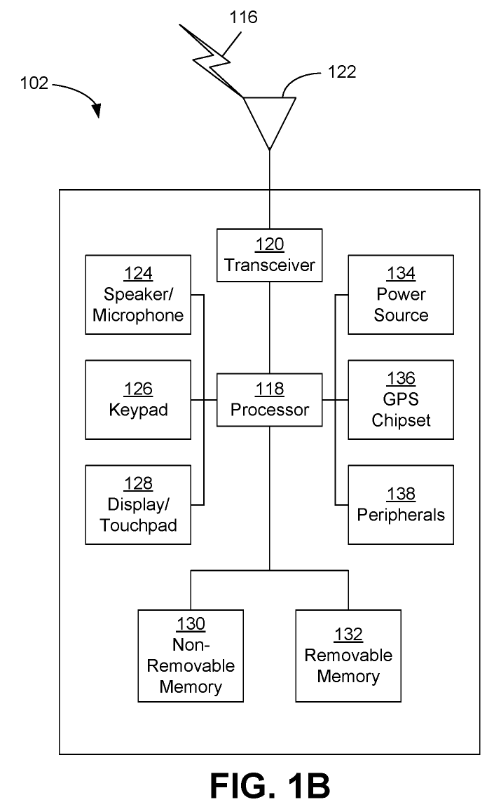

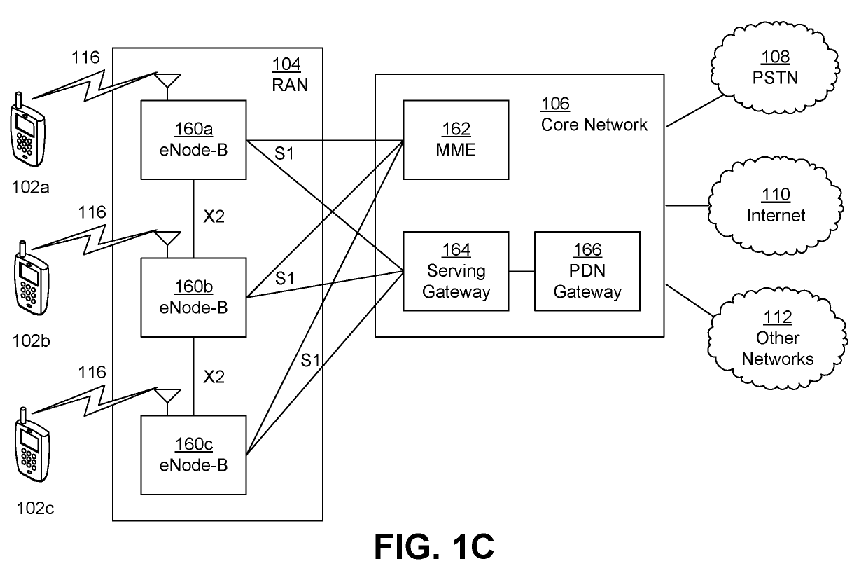

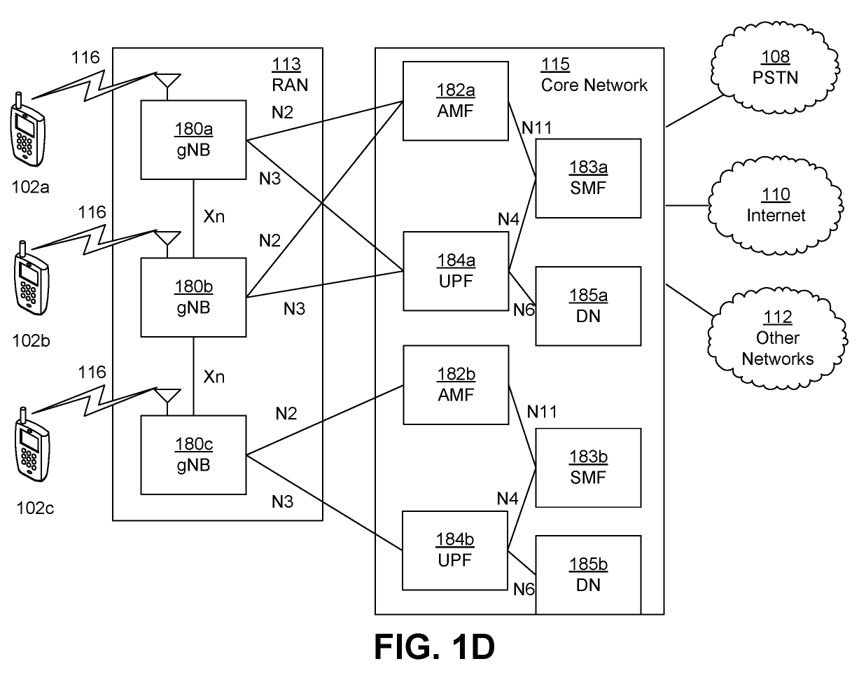

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access , which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Unlike RRC Connected where mobility between cells is network controlled, a WTRU in RRC IDLE/INACTIVE controls its own mobility via cell (re)selection. The WTRU makes measurements of attributes of the serving and neighbour cells to enable the reselection process. Cell reselection identifies the cell that the WTRU should camp on according to the following criteria: Intra-frequency reselection is based on ranking of cells; Inter-frequency reselection is based on absolute priorities where a WTRU tries to camp on the highest priority frequency available; A Neighbour Cell List (NCL) can be provided by the serving cell to handle specific cases for intra- and inter-frequency neighbouring cells; Exclude-lists can be provided to prevent the WTRU from reselecting to specific intra- and inter-frequency neighbouring cells; and Allow-lists can be provided to request the WTRU to reselect to only specific intra- and inter-frequency neighboring cells.

One of the key challenges towards integrating reliable ML solutions into the next generation wireless systems is to provide trust and understanding of how AIML models work. By offering insights into how models work and generate predictions, XAI helps identify the appropriate configuration under which the AIML model may achieve the anticipated performance. Knowing the appropriate configuration along with the conditions needed for a specific AIML model to achieve a target performance, may result in an optimized AIML-based system operation.

This, however, requires a well-defined XAI framework that can identify such configurations and conditions. In particular, the following problems are addressed. How to enable NW-controlled system optimization using, e.g., complexity reduction, reference signal (RS) overhead reduction, using UE-sided XAI model explanations? How to determine the XAI parameters, e.g., explainability mode? How to select samples for XAI model explanations? What are the triggers for XAI model activation and report transmission?

A WTRU may perform one or more procedures for XAI based (e.g., overhead/complexity/power saving) optimization.

Methods for determining and reporting the XAI parameters for NW-controlled performance optimization based on WTRU determined XAI capabilities and/or one or more triggers and/or function of one or more measurements associated with the XAI model outcome satisfying a configured criterion.

The WTRU may determine and/or report its XAI capability to the network. The XAI capability of the WTRU may include one or more WTRU supported use-cases to perform XAI (e.g., CSI prediction, beam management, PMI selection, etc., e.g., report a binary flag per use-case), an explainability mode supported for each use case (e.g., local, global, both), one or more computational resources specific to each use-case to perform XAI, a maximum number of computational resources that can be used to support XAI and/or generate the XAI report(s), and/or a maximum number of storage/memory resources for XAI samples.

The WTRU may receive a configuration (e.g., XAI configuration information) from a network. For example, the XAI configuration information may be used by the WTRU for determining and/or indicating XAI reports. The WTRU may receive the configuration from the NW. The configuration may include a configuration of WTRU-sided XAI reporting, a configuration of XAI outcomes storage/recordings, a configuration of one or more triggers for XAI reporting, and/or a reporting configuration for the XAI report. The configuration of WTRU-sided XAI reporting may include an explainability mode (e.g., a local mode where the WTRU supports per-sample explanation and/or a global mode where the WTRU supports a global explanation that provides global insights about the inference model, for example, the most impactful features associated with a given AIML model) and/or an explainability domain type (e.g., Type I; variables associated with input sample and/or Type II; sample sequence over time).

The configuration of XAI outcomes storage/recordings may include a starting time (e.g., always when XAI model is activated, or started based on NW request), a length of recording (e.g., as a function of number of samples, time slots, inference runs), and/or an outcome format (e.g., one or more XAI scores associated with all features, a rank of features, a metric associated with score, and/or raw samples to be explained. The metric associated with the score may include scores greater than a configured threshold.

The reporting configuration for the XAI report may include one or more resources for reporting, periodicity, and/or XAI metric(s). The XAI metric(s) may include one or more functions of the outcome(s).

The WTRU may run the AIML inference model, for example, based on the configured use-case. The WTRU may activate an XAI model associated with the inference model, for example, based on one or more of a capability availability of the WTRU or an explicit NW indication (e.g., a NW request). The explicit NW indication may indicate relevant samples/XAI outcome for deriving an XAI metric. The explicit NW indication may imply sample storage at the WTRU. For example, if the explicit NW indication is received at slot N, the indication k in the request may refer to the samples/XAI outcome derived from the reference RS (e.g., CSI-RS) at slot N-k.

The WTRU may determine one or more XAI parameters associated with an XAI model (e.g., the activated XAI model). The one or more XAI parameters may indicate one or more features that have a greatest impact on predictions made by the AIML inference model. For example, the one or more XAI parameters may include one or more of the following. The one or more XAI parameters may include an explainability mode. The explainability mode may be a local explainability mode, a global explainability mode, or both. For example, the explainability mode may indicate whether the WTRU is capable of providing local explanations, global explanations, or both. The WTRU may determine the explainability mode based on a NW configuration/request. The WTRU may determine the explainability mode based on a computational capability (e.g., global explanations may require higher computational capabilities). The WTRU may determine the explainability mode based on a rate of change of the importance order of input features. Higher rates of change may indicate frequent changes of impactful features over time such that the WTRU may select the local explainability mode. The WTRU may determine the explainability mode based on a model state. For example, the global explainability mode may be needed after a model update, switch, fine-tune, and/or first failure (e.g., performance degradation) since deployment.

The one or more XAI parameters may include an explainability domain type. The explainability domain type may include a Type I explainability domain type (e.g., variables associated with input sample) or a Type II explainability domain type (e.g., sample sequence over time). The WTRU may determine the explainability domain type based on NW configuration (e.g., the configuration information received from the network). The WTRU may determine the explainability domain type based on a measured rate of change of parameters associated with each domain. For example, for CSI prediction/TSF, the WTRU may select Type II if there are frequent changes in the time domain parameter (e.g., coherence time, speed) and/or the WTRU may select Type I in case of more changes in the spatial-frequency parameters (e.g., delay spread or antenna config, subband dim, etc.).

The WTRU may determine one or more outcomes of the XAI model and/or derive an XAI model metric, for example, based on the determined XAI parameters and/or the NW configuration/request. The one or more outcomes of the XAI model may indicate an importance of one or more features to outputs of the AIML inference model. For example, the one or more outcomes of the XAI model may include one or more of scores associated with an importance of input features with respect to an output of the AIML inference model or scores associated with an inference decision associated with the XAI model. The importance of one or more features may be indicated using the score(s) associated with the importance of input features and/or the score(s) associated with the inference decision associated with the XAI model.

The WTRU may evaluate the XAI model metric against the NW configuration for triggering an XAI report. For example, the WTRU may determine whether to trigger an XAI report based on the evaluation of the XAI model metric against the configuration information. The WTRU may determine whether to trigger an XAI report based on performance boosting criteria. The performance boosting criteria may be associated with one or more use-cases. For example, the performance boosting criteria may include optimizing the observation window associated with the temporal spatial frequency (TSF) compression. For example, XAI outcomes that temporal samples in observation windows are roughly equally important or latest sample in observation window has an XAI score greater than threshold – implies an increase in observation window at the WTRU and/or NW for enhanced reconstruction performance. The performance boosting criteria may include PMI selection (e.g., when SGCS/NMSE performance drops below a configured threshold, the NW may update the codebook parameters for better performance, e.g., oversampling parameters O1, O2). The performance boosting criteria may include beam selection (e.g., RSRP/SINR drops below a threshold). The WTRU may determine whether to trigger an XAI report based on overhead/power consumption reduction criteria. The overhead/power consumption reduction criteria may include channel estimation (CHEST). Based on the XAI outcomes, a number of irrelevant subcarriers (e.g., subcarriers with low XAI scores) less than a threshold may imply CSI-RS overhead reduction. The overhead/power consumption reduction criteria may include CSI prediction. XAI outcomes that indicate some temporal samples scores are below a threshold may imply that the NW is adjusting/reducing CSI-RS periodicity. The WTRU may determine whether to trigger an XAI report based on complexity reduction criteria. The complexity reduction criteria may include TSF. For example, XAI outcomes may indicate that some temporal samples scores are below a threshold so not required for storage and usage as an input to the WTRU and/or NW models.

The WTRU may transmit the XAI report. The XAI report may include one or more XAI parameters (e.g., explainability mode and/or explainability domain type) and/or a cause/reason/parameters. The cause/reason/parameters may be associated with CHEST. For example, The WTRU may remove a subset of the samples or ineffective features/results in input space dimensionality reduction/parameters (e.g., the subcarriers for which the RS can be skipped). The cause/reason/parameters may be associated with TSF. For example, the WTRU may add more samples to the observation window/results in performance improvement/parameters (e.g., a number of samples to add to the observation window). The XAI report may be triggered periodically (e.g., XAI report may be indicated every n configured period). The XAI report may be triggered when one or more of the optimization criteria is satisfied. The XAI report may be triggered based on a NW request. Actual signaling may be based on L1 or RRC or MAC CE.

First AIML model may refer to the AIML model that needs to be explained. The terms first AIML model, inference model and AIML model maybe used interchangeably herein to indicate the model that needs to be explained.

Second AIML model may refer to the model used to explain and/or characterize the first AIML model. For example, the second AIML model may be an XAI model (e.g., LIME, that is used to provide explanations for the AIML inference model, wherein explanations maybe associated with the inference model input and/or output).

XAI outcome may refer to one or more outputs of the XAI model. A first output may represent scores and/or weights representing the importance of the input features with respect to the output of the AIML inference model. A second output may represent an inference decision associated with the XAI model.

XAI metric may refer to a function and/or post-processing of the XAI outcome. For example, the XAI metric may refer to the K feature indices with the highest scores or weights. For example, the XAI metric may be a binary vector where a value of 1 indicates that an input feature score exceeds a certain threshold and a value of 0 indicates otherwise.

A WTRU may perform XAI based (e.g., overhead, complexity, and/or power saving) optimization. The WTRU may report one or more XAI capabilities.

The WTRU may support one or more AI/ML based use cases from the context of explainability and explainable AI. The WTRU may determine a capacity and/or a capability to support the number of use cases and report the type of supported uses cases. For example, the WTRU may report that the WTRU can support up to N use cases relating to CSI based applications, PHY layer-based applications, and/or MAC-layer based applications. For example, the WTRU may report the exact set of use cases that the WTRU supports from the explainability perspective. For example, the WTRU may report that the WTRU can support CSI prediction, CSI compression, and/or PMI selection use cases for explainability. The WTRU may report a binary flag associated with each of the use cases, for example, for reporting the identity of the use cases that are supported. For example, the WTRU may report a value of 1 to signal a specific use case is supported and the WTRU may report a value of 0 to indicate that the use case is not supported. Additionally or alternatively, the WTRU and NW may agree on a dictionary of IDs and/or corresponding potential use cases and at reporting time, the WTRU may indicate (e.g., only indicate) the specific IDs associated with each of the supported use cases.

The WTRU may determine and/or report the explainability mode supported for each use case. In examples, the WTRU may support different explainability modes such as the local explainability mode, the global explainability mode, or a combined explainability mode. In the local or per frame explainability mode, the XAI model or framework may provide explanations or interpretations associated with the performance of the use case specific AI/ML model (e.g., CSI prediction) for a current frame and/or time index or the current data point being processed or in the neighborhood of the data point or time frame being processed. The XAI model may provide explanations related to feature importance, score, ranking of the features, selecting the top K features, and/or selecting the features with magnitudes above a predefined threshold. The explanations may be grounded in (e.g., only in) the current frame, sample, and/or within the neighborhood of the current frame/sample being processed.

In the global explainability mode, the XAI model and/or framework may provide explanations or interpretations associated with the performance of the use case specific AI/ML model (e.g., CSI prediction) across a much larger window of time period or across multiple (e.g., all) frames or across a large subset (e.g., the complete set) of data points over which the inference needs to be performed. The XAI model may provide more general explanations or trends relating to feature importance, score, ranking of the features, selecting the top K features, and/or selecting the features with magnitudes above a predefined threshold, for example, across the entire or a large section of the data.

In the combined (e.g., local and global) explainability mode, the XAI model or framework may provide explanations or interpretations associated with the performance AI/ML model and/or the AI/ML model features across both local and global contexts.

The WTRU may report the set of compute, time, and memory requirements associated with the XAI framework for each of the use cases (e.g., CSI prediction, beam management, PMI selection, etc.) and for each mode of operation (e.g., local explainability mode, global explainability mode, both, etc.). For example, the resources required for running in local mode maybe overall much larger as at each time step the XAI model needs to be run. Additionally or alternatively, the XAI model for local explanation mode maybe smaller and require lower GPU/CPU memory as the WTRU may observe and processes the explanation for a single and/or local set of frames/data points, whereas the global explainability model may need to process much larger dimensional input data to offer global explanation.

The WTRU may report information about the computational resources available to support XAI and/or generate one or more XAI reports. For example, the WTRU may report the amount of CPU, GPU cores available and/or CPU/GPU RAM available to run the XAI models across one or more (e.g., all) use cases or a certain class of use cases (e.g., such as all CSI related use case, or all physical layer related use cases, etc.).

The WTRU may report information about the memory and storage resources available to support XAI and generate the XAI reports. For example, the WTRU may report the amount of scratch and persistent memory available to support XAI models across all use cases or a certain class of use cases (e.g., all CSI related use case, or all physical layer related use cases, etc.). Information about the memory and storage resources available to support XAI and generate XAI reports may be important to select which use cases or which combination of use cases could be parallelly supported by the WTRU, whether local explainability mode is viable, and/or whether global explainability mode is more viable than local explainability mode.

A WTRU may be configured with a first AIML model and an associated second AIML model. The first AIML model may be an inference model used for a specific task/use-case (e.g., CSI compression, positioning, beam management, etc.). The second AIML model may be used to explain and/or interpret the performance and/or operation of the first model. For example, input to the second AIML model may include one or more of the following: the first AIML model, inputs to the first AIML model, or outputs from the first AIML model. The second AIML model may be an XAI model. The frequency of running the XAI model may be smaller than the frequency of running the first AIML model. The frequency of running the XAI model may be based on the behavior of the first AIML model. The second AIML model may be used to optimize the performance of the first AIML model which in turn results in better performance of the entire system, for example, satisfying at least one of the following optimization criterions: performance improvement, complexity reduction, or overhead reduction.

The WTRU may be configured to determine and indicate an XAI report. The configuration may include specific XAI parameters (e.g., such as explainability mode and/or explainability type, XAI outcomes storage/recordings, and/or XAI reporting configuration, and/or triggers for XAI reporting).

The configuration of XAI parameters reporting may include at least one of the explainability mode and the explainability domain type. For example, the explainability mode may be a local explainability mode. The local explainability mode indicates that the XAI model is capable of providing per-sample explanations (e.g., most impactful input features for each inference instance). In another example, the explainability mode may be a global explainability mode. The global explainability mode indicate that the XAI model is capable of providing global explanations about the inference model. For example, the XAI model may indicate information about one or more dominant input features impacting the decisions and/or prediction of the inference model. In another example, the WTRU may indicate the XAI model support of both the local explainability mode and the global explainability model.

The WTRU may be configured to indicate the explainability domain type. The explainability domain type may be Type I, wherein the XAI model provides explanations about the input features associated with a given input sample. The explainability domain type may be Type II, wherein the XAI model provides explanations for a series of consecutive input samples. For example, the WTRU may indicate the temporal samples importance in a specific observation window associated with an AIML model. For example, for the CSI TSF compression or CSI prediction use case, Type II explainability domain type means that the XAI model can identify the importance of the different temporal samples in the observation window.

A WTRU may be configured to store and/or record one or more XAI outcomes. An XAI outcome may refer to one or more outputs of the XAI model. A first output may represent one or more scores and/or weights representing an importance of one or more input features with respect to the output of the AIML inference model. A second output may represent an inference decision associated with the XAI model. The WTRU may be configured with the starting time for recording and/or storing the outcome. For example, the starting time may be associated with the activation of the XAI model. For example, the starting time may be based on an explicit request from the NW. The starting time may be associated with an XAI metric exceeding a configured threshold. The WTRU may be configured with the length of the recording expressed in number of inference sample or number of consecutive XAI runs, time slots, time units in ms, etc.

The WTRU may be configured with a format for storing the one or more XAI outcomes. For example, a first format may be associated with an outcome of the XAI model (e.g., first output or second output). A second format may be associated with an XAI metric (e.g., such as a function of the XAI model outcome). For example, the XAI metric may be a rank of the features based on the respective scores. The XAI metric may be a set of scores greater than a configured threshold. The XAI metric may be one or more features indices associated with the scores exceeding the configured threshold. The XAI metric may be one or more raw samples to be explained. The XAI metric may be a representation of the one or more raw samples.

A WTRU may be configured to activate and/or run the XAI model based one or more triggers (e.g., trigger conditions). The frequency of running the XAI model may be smaller than the frequency of running the inference model. The frequency of running the XAI model may be based on the behavior of the inference model and/or based on an NW explicit indication (e.g., for the purpose of optimizing the system performance). The one or more triggers to activate/run the XAI model may at least include one of the following. The one or more triggers may include a length of recording of XAI outcomes. For example, the WTRU may be configured to run the XAI model as long as the number of recorded samples is below a configured threshold. The one or more triggers may include time. For example, the WTRU may be configured with one or more time instances, one or more slots, and/or a periodicity type when the WTRU can activate the XAI model. For example, the time may be a function of the inference model runs (e.g., inferences) such that the WTRU is configured to run the XAI model every N inference occasions.

The one or more triggers may include a performance of the inference model. For example, when the performance of the inference model goes below a configured threshold, the WTRU may be triggered to activate and/or run the XAI model.

The one or more triggers may include a change in scenario and/or configuration associated with the inference model. For example, the WTRU may receive an indication of a change in scenario and/or configuration associated with the inference model. Scenarios may include at least one of: WTRU mobility (e.g., speed), a channel/environment type (e.g., such as indoor/outdoor), and/or a link type (e.g., LOS, NLOS). The configuration may include at least one of: a carrier frequency, a bandwidth part, and/or an antenna layout.

The one or more triggers may include a determination that an inference model event has occurred. For example, the inference model event may include at least one of: a model retraining, a finetuning, a switching, and/or a deactivation.

The one or more triggers may include an inference model performance monitoring parameters change below a threshold. For example, the inference model performance monitoring parameters may include at least one of: a confidence level of the inference model output/decision/prediction and/or one or more convergence parameters of the inference model.

The one or more triggers may include a system performance associated function. For example, a rate of HARQ-NACK may trigger the WTRU to run and/or activate the XAI model when the number of NACKs exceeds a configured threshold.

The one or more triggers may include a failure and/or a change in link conditions. For example, the failure and/or change in link conditions may include a beam failure, a Radio Link Failure, and/or a handover failure.

The one or more triggers may include a status of a previous feedback. For example, the WTRU may run and/or activate the XAI model if previous feedback associated with the inference model is dropped or received at the NW with error (e.g., based on CRC check).

The XAI reporting configuration may include which XAI measurements are to be reported, the reporting type (e.g., periodic, semi-persistent or aperiodic), and/or resources for reporting. The XAI measurements to be reported may include XAI metric(s) and/or XAI outcome(s).

The WTRU may be configured to report use-case specific XAI metrics, for example, when the WTRU supports AIML inference models for multiple use cases. For example, for AI/ML based CSI prediction, the WTRU may be configured to report an order of the input features (e.g., historical CSI), which may be evaluated against one or mode ordered sets. In another example, for AI/ML based CSI prediction, the WTRU may be configured to report a number of most impactful features compared against a configured threshold. In another example, for CSI compression using temporal-spatial-frequency domain information, the reported XAI metric may include a minimum allowed score associated with each sample in the observed window.

The XAI reporting configuration may include resources for reporting the XAI parameters including at least one of the explainability mode and the explainability domain type.

When one or more configured XAI conditions are met, the WTRU may be triggered to run and/or activate the XAI model and determine the XAI outcome(s) and/or XAI metric(s).

A WTRU may be configured with a first AI model and an associated second AI model. The first AI model may be used for a specific use case (e.g., beam management, positioning, CSI feedback enhancement) and the second AI model may be used to characterize, explain, and/or comprehend the operation, output, and/or performance of the first AI model. Input to the second AI model may include the first AI model, inputs to the first AI model, and/or outputs from the first AI model. The second AI model may be an XAI model.

The WTRU may be configured to store one or more samples for XAI metric/parameter determination. In examples, the samples may be the input and output associated with first AI model. In examples, the samples may be the input and output associated with the XAI model. In examples, the samples may be one or more RS measurements and/or a processed version thereof. In examples, the samples may be intermediate values based on AI mode processing. In examples, the WTRU may be configured to store the samples upon one or more preconfigured conditions. In examples, the WTRU may store the samples upon activation of the XAI model. In examples, the WTRU may store the samples when the performance of the first AIML model goes below a threshold. In examples, the WTRU may be configured to store the samples when explicitly requested by the network. Example trigger conditions are described herein.

The WTRU may be configured to perform one or more actions associated with buffer handling. For example, the WTRU may be configured to store the last N samples. The value of N may be a function of WTRU capability and/or NW configuration. In examples, the WTRU may be configured to assign a priority to the samples in the buffer. For example, the WTRU may assign a higher priority to samples associated with performance of the first AI model below a threshold. For example, the WTRU may assign a higher priority to samples associated with NACK reception. For example, the WTRU may assign a higher priority to samples associated with one or more of Beam Failure, Radio Link Failure etc. The WTRU may receive explicit indication from the NW. An explicit indication from the NW may indicate to prioritize samples within a preconfigured time interval. When a buffer is full, the WTRU may be configured to delete the oldest sample in the buffer and/or delete the lowest priority sample from the buffer. The WTRU may be configured to calculate one or more XAI parameters/metrics based on a subset of samples stored in the buffer. The subset of samples may be explicitly indicated in a request/command from the gNB (e.g., based on one or more solutions described herein). The subset of samples may be implicitly indicated in a request/command from the gNB. For example, the WTRU may receive the gNB request/command at slot N, the indication k in the request may refer to the samples/XAI outcome derived from the reference RS (e.g., CSI-RS) at slot N-k. The WTRU may determine the XAI parameters/metrics (e.g., based on methods described herein) and/or transmit the XAI report (e.g., based on methods described herein), for example, upon determining the relevant subset of samples.

The WTRU may be configured to flush the buffer (e.g., delete a subset of samples), for example, upon sending an XAI report associated with a subset of samples. The WTRU may be configured to set a priority of samples to low priority upon transmission of an XAI report associated with those samples. The WTRU may be configured to flush the buffer upon fallback to legacy, upon deactivation of the first AI model, and/or upon model switch. The WTRU may be configured to flush the buffer upon reconfiguration of inputs to the first AI model (e.g., including reconfiguration of RS and/or one or more parameters of AI model operation including observation window/prediction window configuration). The WTRU may be configured to flush the buffer upon events such as handover, reconfiguration with sync, BWP switching etc.

A WTRU may be configured to determine one or more XAI parameters associated with the XAI model operation. The one or more XAI parameters may include the explainability mode and/or the explainability domain type. The explainability mode may be a local mode indicating that the XAI model supports a sample-by-sample explanation, wherein the sample-by-sample explanation provides a characteristic associated with the input features within each sample (e.g., an importance score for each input feature). The explainability mode may be a global mode indicating a global explanation about the inference model, wherein the global explanation provides a generic view on the key features impacting the inference model decisions and/or predictions. The XAI model with global explanations may require less computational capabilities than the XAI model with local explanations since the XAI model with local explanations requires running the model for each sample. The WTRU may be configured to determine and/or report the explanation mode based on one or more conditions that include one or more of the following.

The one or more conditions may include an explicit NW configuration/request. The WTRU may be configured to store/record local explanations for specific samples and/or provide global explanations about the inference model.

The one or more conditions may include one or more WTRU computational capabilities. The WTRU may determine the explainability mode based on its computational capabilities. For example, a global explainability mode may be associated with a lower amount of computations when compared to a local explainability mode.

The one or more conditions may include a rate of change of input features with respect to importance. The WTRU may determine (e.g., after a few runs of running the XAI model in a local mode) that the key impactful features are not changing over time or changing with low frequency. This may be indicating that a global explainability mode may be more appropriate/efficient for explaining the inference model. If the impactful input features are changing more frequently from one sample to another, then a local explainability mode may be a more appropriate choice.

The one or more conditions may include an inference model state. The WTRU may determine to use a global explainability mode based on an update to the inference model. For example, the update to the inference model may include an initial deployment of the inference model or model switch event, a model fine-tune event, and/or a model failure event.

The WTRU may be configured to determine an explainability domain type (e.g., a Type I explainability domain type or a Type II explainability domain type). The Type I explainability domain type may be associated with explanations of input features within a sample at given time. The Type II explainability domain type may be associated with explanations of a sequence of samples over time wherein each sample is considered as a single feature. For example, for use-cases dealing with time-series data as prediction models, e.g., CSI or RRM, or TSF model, or joint prediction and compression model, Type I explainability domain type may be required to explain the features within a sample at specific time, e.g., different scores for the different frequency resources in the TSF use-case. Type II explainability domain type, however, may provide a temporal sample importance which may help with optimizing the length of observation window which in turn enhances the system performance either from computational and memory complexities or performance improvement or overhead reduction.

The WTRU may determine the explainability domain type based on one or more of the following. The WTRU may determine the explainability domain type based on NW configuration. For example, the NW may indicate to the WTRU whether to store/record feature scores associated with Type I explanations (e.g., Type I explainability domain type) and/or Type II explanations (e.g., Type II explainability domain type). The WTRU may determine the explainability domain type based on a measured rate of change of parameters associated with each domain. For example, for time-series based use cases (e.g., CSI prediction/TSF) the WTRU may select the Type II explainability domain type if there are frequent changes in the time domain parameter (e.g., coherence time, speed) or the WTRU may select the Type I explainability domain type in case of more changes in the spatial-frequency parameters (e.g., delay spread or antenna configuration).

A WTRU may evaluate one or more configured trigger conditions for triggering an XAI report request. The evaluation of trigger conditions may be based on one or more of the following. The evaluation of trigger conditions may be based on operational performance of the inference model, for example, such that the XAI report is triggered based on configured operational performance thresholds. The operational performance of the inference model may include performance boosting criteria such as TSF, PMI selection, and/or beam selection. For example, an XAI report may be triggered if XAI outcomes indicate that temporal samples in observation window are roughly equally important or latest sample in observation window has an XAI score greater than threshold. This implies an increase in observation window at the WTRU and NW for enhanced reconstruction performance. An XAI report may be triggered if XAI outcomes indicate that SGCS/NMSE performance drops below a configured threshold. This implies that the NW may update the codebook parameters for better performance (e.g., O1, O2). An XAI report may be triggered if XAI outcomes indicate that RSRP/SINR drops below a threshold.

The operational performance of the inference model may include overhead/power consumption criteria such as CHEST and/or CSI prediction. For example, an XAI report may be triggered if XAI outcomes indicate that number of irrelevant subcarriers (e.g., subcarriers with low XAI scores) is greater than a threshold. This implies CSI-RS overhead reduction. An XAI report may be triggered if XAI outcomes indicate that some temporal samples scores are below a threshold. This implies NW adjusting/reducing CSI-RS periodicity. The operational performance of the inference model may include complexity reduction criteria such as TSF. For example, an XAI report may be triggered if XAI outcomes indicate that some temporal samples scores are below a threshold. This implies that some temporal samples are not required for storage and usage as an input to the UE and NW models.

The evaluation of trigger conditions may be based on a performance of model monitoring. For example, an XAI report may be triggered based on one or more configured model monitoring thresholds. For example, an XAI report may be triggered based on a confidence level of inference model output/decision/prediction (e.g., when the confidence level of the model output/decision/prediction is below a configured threshold). An XAI report may be triggered based on one or more convergence parameters of the inference model (e.g., when the gap between training loss and inference/validation loss is above a threshold). An XAI report may be triggered based on historical accuracy of the inference model (e.g., when the accuracy of the model is below a configured threshold). The XAI report may include the triggering event (e.g., model monitoring), the reason for the event (e.g., model not generalizing to current conditions), and/or one or more suggested parameters (e.g., change of model, or model parameters).

The evaluation of trigger conditions may be based on system performance of an associated function, such that an XAI report is triggered based on configured thresholds on system performance. The system performance may include a rate of HARQ-NACK. An XAI report may be triggered when the HARQ-NACK rate is above a threshold. The system performance may include a block error rate. An XAI report may be triggered when a BLER is above a threshold. The system performance may include a throughput. An XAI report may be triggered when the throughput is below a threshold.

The evaluation of trigger conditions may be based on changes on inference model. An XAI report may be generated based on a change in inference model including model retraining, model fine tuning, model switching, model deactivation, and/or model activation.

The evaluation of trigger conditions may be based on a change in scenario associated with the inference model. An XAI report may be triggered when the WTRU determines (e.g., or receives an indication associated with) a scenario change. The change in scenario may include mobility (e.g., WTRU speed exceeding a configured threshold). The change in scenario may include a channel/environment type (e.g., when the WTRU environment changes from indoor to outdoor or outdoor to indoor). The change in scenario may include a link type (e.g., when a WTRU to NW link changes from LOS to NLOS or NLOS to LOS).

The evaluation of trigger conditions may be based on a change in configurations associated with the inference model. An XAI report may be triggered when the WTRU is indicated with (e.g., receives an indication associated with) a change in configurations (e.g., carrier frequency, bandwidth part, antenna layout, subcarrier spacing, etc.).

The evaluation of trigger conditions may be based on a configured timing. An XAI report may be triggered based on the current time instance and configured reporting timing. For example, the WTRU may generate an XAI report based on configured slots, timing instances, and/or periodicity.

The evaluation of trigger conditions may be based on a number of XAI reports. An XAI report may be triggered based on the configured number of XAI reports. For example, the WTRU may run the XAI model (e.g., and generate XAI reports) until the configured number of XAI reports is achieved.

A WTRU may be configured to report the one or more aspects associated with the outcome of the XAI model. For example, the WTRU may be configured to report (e.g., via an XAI report) the one or more metrics derived based on the outcome of the XAI model. The terms XAI metric and XAI parameters may be used interchangeably herein. A WTRU capable of AIML operation (e.g., and (possibly) configured for AIML operation), may transmit one or more indications, reports, and/or feedback including one or more of: information related to behavior of the first model, performance of the first AI model, importance of specific inputs to the first AI model, most influential input for a specific output, interpretation of output of the first AI model, and/or reasoning for specific actions taken based on the first AI model output. The WTRU may apply one or more XAI techniques and/or methods to generate the indications, reports, and/or feedback. For example, the indications, reports, and/or feedback may be based on one or more samples stored at the WTRU. The indications, reports, and/or feedback may be referred to herein as an XAI report.

An XAI report may include the XAI mode and/or domain information. For example, XAI mode may include explainability mode. For example, the explainability mode may be local, global or both. The explainability mode may be determined based on one or more of: a NW configuration, a computational capability of the WTRU, a rate of change of input features, and/or a model status. The XAI report may include an explainability domain type. For example, explainability domain type 1 may be associated with an input sample. For example, explainability domain type 2 may be associated with a set of input samples (e.g., sequence over time). The XAI report may include information about use cases (e.g., BM/POS/CSI etc.), functionality, and/or model identity associated with the XAI report. The XAI report may include a cause for the XAI report. For example, in a channel estimation use case, the WTRU may indicate the subset of samples and/or features/results for input space dimensionality reduction. The WTRU may indicate that a removal of such inputs/features may not impact the performance of the model. For example, the WTRU may indicate the subcarriers for which the RS can be skipped. For example, in TSF compression use case, the WTRU may indicate a change and/or adaptation of observation and/or prediction window configuration for performance improvement and/or overhead reduction. For example, the WTRU may indicate a number of samples to add to the observation window that can potentially improve the performance by a preconfigured threshold. The WTRU may indicate the measurement and/or input samples associated with the XAI report. The WTRU may indicate a buffer status associated with the XAI samples. For example, the indication may be in terms levels low, med, high or different granularity thereof.

The WTRU may be configured to transmit the XAI report periodically. For example, the periodicity of the XAI report transmission may be configured as X milliseconds. In another example, the XAI report periodicity may be configured as a function of a periodicity of the RS (e.g., CSI-RS, PRS etc.) associated with the AI model input. The WTRU may be configured to transmit the XAI report based on a NW request. The WTRU may transmit the XAI report when one or more preconfigured conditions are satisfied. For example, the criteria may be an optimization objective. The optimization objective may be one or more of: overhead reduction, performance improvement, power savings, and/or complexity reduction. The WTRU may transmit the XAI report when the sample buffer occupancy exceeds a preconfigured threshold, (e.g., 80%, 90%, 95% etc.).

A WTRU may be preconfigured with UL resources for transmission of an XAI report. The WTRU may transmit an XAI report in response to a NW command requesting for transmission of the XAI report. The WTRU may receive an UL grant for transmission of an XAI report in the NW command requesting for transmission of the XAI report.

The WTRU may transmit the XAI report in L1 Uplink Control Information. The WTRU may transmit the XAI report as a part of CSI feedback. Such reporting (e.g., transmitting the XAI report) may be periodic, semi-persistent, and/or event triggered. For example, the WTRU may be configured with an XAI reporting type that indicates one or more of an XAI outcome, an XAI metric, a root-cause failure (RCF) type, or a recommended recovery action. For example, the WTRU may be configured with a CSI report quantity that indicates the XAI reporting type. The WTRU may be configured to transmit an XAI report based on expiry of a preconfigured timer. The WTRU may be configured to transmit an XAI report periodically (e.g., wherein the periodicity may be implicitly configured based on the periodicity of a preconfigured reporting resource and/or a periodicity of a RS (e.g., CSI-RS) configured for XAI operation). The WTRU may be configured to transmit an XAI report for every N inferences of the first AI model (e.g., inference model). The WTRU may be configured to transmit an XAI report for every N ms/slots, for example, as long as the associated first AI model (e.g., inference model) is active. The WTRU may be configured to report one or more (e.g., all) XAI parameters with the same periodicity. The WTRU may be configured to report different XAI parameters at different periodicities.

The WTRU may transmit one or more XAI report parameters in a RRC message. For example, the WTRU may receive a configuration for XAI report in RRC reconfiguration. The WTRU may transmit an XAI report in a RRC reconfiguration complete message. The WTRU may transmit an XAI report in a WTRU Assistance Information message. The WTRU may receive an XAI report configuration in a WTRU information request message. The WTRU may transmit an XAI report in a WTRU information response message. The WTRU may determine the XAI parameters and/or trigger an XAI report for an AI model when the performance of the AI model is below a threshold. The WTRU may be configured to transmit an XAI report along with an AI model performance monitoring report.

The WTRU may transmit an XAI report in a MAC CE. For example, the WTRU may be configured to transmit an XAI report in a MAC-CE as a response to a MAC-CE requesting the XAI report. The WTRU may receive an XAI report activation/deactivation command in a MAC CE. When activated, the WTRU may transmit the XAI report in the MAC CE. The XAI activation/deactivation command may include one or more of an XAI reporting type, an associated inference model ID/functionality ID, a periodicity, and/or an UL resource config for reporting. The XAI activation/deactivation command may include an index associated with an XAI reporting configuration.

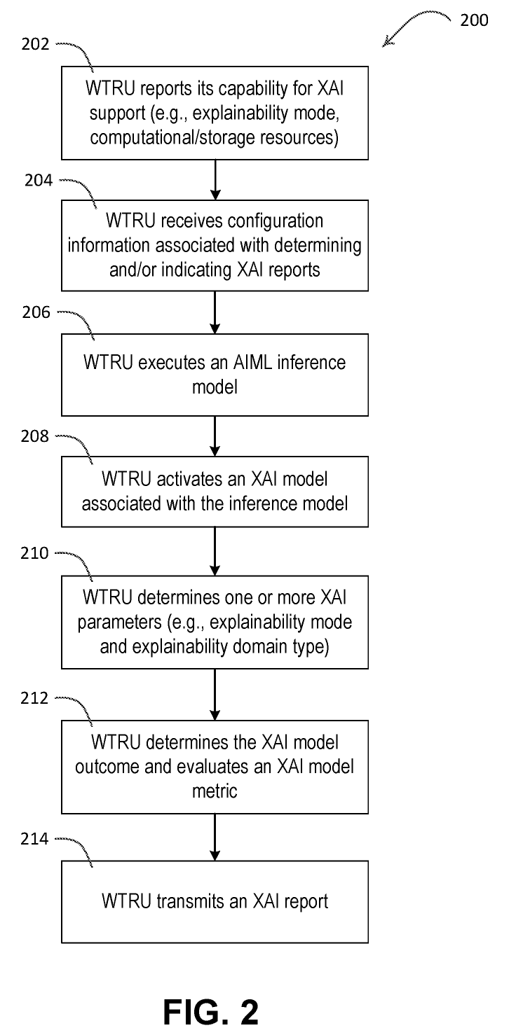

FIG. 2 is a flow diagram of an example WTRU procedure for XAI based optimization 200. The XAI based optimization 200 may be associated with overhead reduction, complexity reduction, and/or power saving. A WTRU may be configured to determine and/or report XAI parameters for NW-controlled performance optimization based on WTRU determined XAI capabilities, one or more triggers, and/or a function of one or more measurements associated with the XAI model outcome satisfying a configured criterion.

At 202, the WTRU may determine and/or report one or more XAI capabilities of the WTRU. The one or more XAI capabilities of the WTRU may include one or more WTRU supported use-cases to perform XAI (e.g., such as CSI prediction, beam management, PMI selection, etc.). The WTRU may report a binary flag per use-case. The one or more XAI capabilities may include an explainability mode supported for each use case (e.g., such as local, global, or both). The one or more XAI capabilities may include computational resources specific to each use-case to perform XAI. The one or more XAI capabilities may include a maximum number of computational resources that can be used to support XAI and generate the XAI report(s). The one or more XAI capabilities may include a maximum number of storage/memory resources for XAI samples.

At 204, the WTRU may receive a configuration (e.g., XAI configuration information) from a network. For example, the XAI configuration information may be used by the WTRU for determining and indicating XAI report(s). The XAI configuration information may include a configuration of WTRU-sided XAI reporting, a configuration of XAI outcomes storage/recordings, a configuration of one or more triggers for XAI reporting, and/or a reporting configuration of the XAI report(s). The configuration of WTRU-sided XAI reporting may include an explainability mode and/or an explainability domain type. The explainability mode may include a local mode where the WTRU supports per-sample explanation and/or a global mode where the WTRU supports a global explanation and/or provides global insights (e.g., most impactful features associated with a given AIML model) about an inference model. The explainability domain type may include a type I where variables are associated with an input sample and/or a type II that is associated with a sample sequence over time. The configuration of XAI outcomes storage/recordings may include a starting time (e.g., always when XAI model is activated, or started based on NW request), a length of recording (e.g., as a function of number of samples, time slots, and/or inference runs), an outcome format (e.g., XAI scores associated with all features, rank of features, metric associated with score (e.g., scores greater than configured threshold)), and/or raw samples to be explained. The reporting configuration for the XAI report may include one or more resources for reporting, periodicity, XAI metric, (e.g., function of the outcome(s)).

At 206, the WTRU may run (e.g., execute) the AIML inference model, for example, based on the configured use-case. For example, the executed AIML inference model may be associated with a use-case (e.g., indicated in the XAI configuration information).

At 208, the WTRU may activate an XAI model associated with the inference model. The WTRU may activate the XAI model based on WTRU capability availability and/or an explicit NW indication. The explicit NW indication may indicate the relevant samples/XAI outcome for deriving the XAI metric (e.g., implies sample storage at the WTRU). If the NW request is received at slot N, the indication k in the request may refer to the samples/XAI outcome derived from the reference RS (e.g., CSI-RS) at slot N-k.

At 210, the WTRU may determine one or more XAI parameters associated with an XAI model (e.g., the activated XAI model). The one or more XAI parameters may indicate one or more features that have a greatest impact on predictions made by the AIML inference model. For example, the one or more XAI parameters may include an explainability mode and/or an explainability domain type. The explainability mode (e.g., local, global, or both) may indicate whether the WTRU is capable of providing local explanations, global explanations, or both local and global explanations. The WTRU may determine the explainability mode based on the received configuration from the network and/or a request received from the NW. The WTRU may determine the explainability mode based on a computational capability. For example, global explanations may require higher computational capabilities than local explanations. The WTRU may determine the explainability mode based on a rate of change of the importance order of input features. Higher rates of change may indicate frequent changes of impactful features over time. The WTRU may select local explanation mode when the rate of change is greater than a threshold. The WTRU may determine the explainability mode based on a model state (e.g., global X may be needed after model update /switch/fine-tune, first failure (performance degradation) since deployment).

The explainability domain type may be a Type I explainability domain type where variables are associated with an input sample and/or a Type II explainability domain type where samples are sequenced over time. The WTRU may determine the explainability domain type based on the received configuration from the NW. The WTRU may determine he explainability domain type based on a measured rate of change of parameters associated with each domain. For example, for CSI prediction/TSF, the WTRU may select Type II if there are frequent changes in the time domain parameter (e.g., coherence time, speed). The WTRU may select Type I in case of more changes in the spatial-frequency parameters (e.g., delay spread or antenna config, subband dim, etc.).

At 212, the WTRU may determine one or more outcomes of the XAI model and/or may derive an XAI metric, for example, based on the determined XAI parameters and/or NW configuration/request. The one or more outcomes of the XAI model may indicate an importance of one or more features to outputs of the AIML inference model. For example, the one or more outcomes of the XAI model may include one or more of scores associated with an importance of input features with respect to an output of the AIML inference model or scores associated with an inference decision associated with the XAI model. The importance of one or more features may be indicated using the score(s) associated with the importance of input features and/or the score(s) associated with the inference decision associated with the XAI model. The WTRU may evaluate, at 212, the XAI model metric against the NW configuration for triggering an XAI report. For example, the WTRU may determine, at 212, whether to trigger an XAI report based on one or more outcomes of the XAI model. For example, the XAI report may be triggered based on performance boosting criteria, overhead/power consumption reduction criteria, and/or complexity reduction criteria. The performance boosting criteria may include TSF. XAI outcomes that temporal samples in observation windows are roughly equally important or latest sample in observation window has an XAI score greater than threshold – implies increase in observation window at a WTRU and/or NW for enhanced reconstruction performance). The overhead/power consumption reduction criteria may include a channel estimation (CHEST). For example, XAI outcomes may indicate that a number of irrelevant subcarriers (e.g., subcarriers having low XAI scores) are below a threshold. When a number of irrelevant subcarriers are below the threshold, CSI-RS overhead reduction may be implied. The overhead/power consumption reduction criteria may include a CSI prediction. For example, XAI outcomes may indicate that some temporal sample scores are below a threshold. When temporal sample scores are below the threshold, NW adjusting/reducing CSI-RS periodicity may be implied. The complexity reduction criteria may include TSF. For example, XAI outcomes may indicate that some temporal sample scores are below a threshold and are not required for storage and/or usage as input to the WTRU and/or NW models

At 214, the WTRU may send the XAI report to the network. The XAI report may include the determined XAI parameters and/or a cause/reason parameter. The cause/reason parameter may include CHEST (e.g., removing a subset of the samples or ineffective features/results in input space dimensionality reduction/ parameters: the subcarriers for which the RS can be skipped) and/or TSF (e.g., adding more samples to the obs window/results in performance improvement/parameters: number of samples to add to the obs window). The XAI report may be triggered periodically (e.g., XAI report may be indicated every n configured period), when one or more of the optimization criteria is satisfied, and/or based on NW request. Actual signaling may be based on L1 or RRC or MAC CE

1. A wireless transmit/receive unit (WTRU) comprising:
a memory and a processor, wherein the processor is configured to:
receive explainable artificial intelligence (XAI) configuration information from a network;
determine one or more XAI parameters associated with an XAI model, wherein the one or more XAI parameters indicate features that have a greatest impact on predictions made by an artificial intelligence (AI) or machine learning (ML) inference model;
determine to trigger an XAI report based on one or more outcomes of the XAI model, wherein the one or more outcomes of the XAI model indicate an importance of one or more features to outputs of the AIML inference model; and
send the XAI report to the network, wherein the XAI report comprises one or more of a cause parameter or the one or more XAI parameters.

2. The WTRU of claim 1, wherein the one or more XAI parameters comprise one or more of an explainability mode or an explainability domain type.

3. The WTRU of claim 2, wherein the explainability mode comprises one or more of a local explainability mode or a global explainability mode and the explainability domain type comprises one or more of a first type where the XAI model provides explanations about input features associated with a given input sample or a second type where the XAI model provides explanations for a series of consecutive input samples.

4. The WTRU of claim 1, wherein the XAI configuration information comprises one or more of an explainability mode, an explainability domain type, a configuration of XAI outcome storage, one or more triggers associated with an XAI report, or an XAI report configuration.

5. The WTRU of claim 1, wherein the one or more outcomes of the XAI model comprises one or more of scores associated with an importance of input features with respect to an output of the AIML inference model or scores associated with an inference decision associated with the XAI model, and wherein the processor is further configured to derive an XAI model metric based on one or more of the XAI configuration information or the one or more XAI parameters.

6. The WTRU of claim 5, wherein the XAI model metric comprises one or more of a rank of the input features based on their respective scores, a set of scores greater than a configured threshold, feature indices associated with the scores that are greater than the configured threshold, raw samples to be explained, or a representation of the raw samples.

7. The WTRU of claim 1, wherein the processor is further configured to execute an artificial intelligence (AI) machine learning (ML) inference model that is associated with a use-case, and wherein the XAI model is associated with the AIML inference model.

8. The WTRU of claim 1, wherein the XAI report is triggered based on one or more of a performance boosting criteria, a power consumption reduction criteria, or a complexity reduction criteria.

9. The WTRU of claim 1, wherein the processor is further configured to determine one or more XAI capabilities of the WTRU.

10. The WTRU of claim 9, wherein the one or more XAI capabilities of the WTRU comprise one or more of WTRU supported use-cases to perform XAI, a supported explainability mode for each of the one or more WTRU supported use-cases, computational resources for each of the use-cases to perform XAI, a maximum number of computational resources that can be used to support XAI, or a maximum number of storage resources for XAI samples, and wherein the WTRU supported use-cases comprise one or more of channel state information (CSI) prediction, beam management, or precoding matrix indicator (PMI) selection.

11. A method performed by a wireless transmit/receive unit (WTRU), the method comprising:
receiving explainable artificial intelligence (XAI) configuration information from a network;
determining one or more XAI parameters associated with an XAI model, wherein the one or more XAI parameters indicate features that have a greatest impact on predictions made by an artificial intelligence (AI) or machine learning (ML) inference model;
determining to trigger an XAI report based on one or more outcomes of the XAI model, wherein the one or more outcomes of the XAI model indicate an importance of one or more features to outputs of the AIML inference model; and
sending the XAI report to the network, wherein the XAI report comprises one or more of a cause parameter or the one or more XAI parameters.

12. The method of claim 11, wherein the one or more XAI parameters comprise one or more of an explainability mode or an explainability domain type.

13. The method of claim 12, wherein the explainability mode comprises one or more of a local explainability mode or a global explainability mode and the explainability domain type comprises one or more of a first type where the XAI model provides explanations about input features associated with a given input sample or a second type where the XAI model provides explanations for a series of consecutive input samples.

14. The method of claim 11, wherein the XAI configuration information comprises one or more of an explainability mode, an explainability domain type, a configuration of XAI outcome storage, one or more triggers associated with an XAI report, or an XAI report configuration.

15. The method of claim 11, wherein the one or more outcomes of the XAI model comprises one or more of scores associated with an importance of input features with respect to an output of the AIML inference model or scores associated with an inference decision associated with the XAI model, and wherein the method further comprises deriving an XAI model metric based on one or more of the XAI configuration information or the one or more XAI parameters.

16. The method of claim 15, wherein the XAI model metric comprises one or more of a rank of the input features based on their respective scores, a set of scores greater than a configured threshold, feature indices associated with the scores that are greater than the configured threshold, raw samples to be explained, or a representation of the raw samples.

17. The method of claim 11, further comprising executing an artificial intelligence (AI) machine learning (ML) inference model that is associated with a use-case, and wherein the XAI model is associated with the AIML inference model.

18. The method of claim 11, wherein the XAI report is triggered based on one or more of a performance boosting criteria, a power consumption reduction criteria, or a complexity reduction criteria.

19. The method of claim 11, further comprising determining one or more XAI capabilities of the WTRU.

20. The method of claim 19, wherein the one or more XAI capabilities of the WTRU comprise one or more of WTRU supported use-cases to perform XAI, a supported explainability mode for each of the one or more WTRU supported use-cases, computational resources for each of the use-cases to perform XAI, a maximum number of computational resources that can be used to support XAI, or a maximum number of storage resources for XAI samples, and wherein the WTRU supported use-cases comprise one or more of channel state information (CSI) prediction, beam management, or precoding matrix indicator (PMI) selection.
